(19) United States
(12) Patent Application Publication
(10) Pub. No.: US 2007/0122005 A1
(43) Pub. Date: May 31, 2007

(54) IMAGE AUTHENTICATION APPARATUS

(75) Inventors: Hiroshi Kage, Chiyoda-ku (JP); Shintaro Watanabe, Chiyoda-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/558,669

(22) Filed: Nov. 10, 2006

(30) Foreign Application Priority Data
Nov. 29, 2005 (JP) 2005-343552

(51) Int. Cl. G06K 9/00

(52) U.S. Cl. 382/115

(57) ABSTRACT

In conventional image authentication apparatuses, in a case in which relatively significant variation of a face image is accompanied when a part of a face is hidden by a mask or sun-glasses, etc. during a matching operation, it has been difficult to treat the image as an authentication target. When the part of the face is also hidden by the mask or the sun-glasses, etc. during the matching operation, by outputting a recollected image, using as an input image a face image extracted by a target extraction unit, by an image recollection unit provided with an associative memory circuit, partial hiding and facial-expression variation, etc. included in the input image are complemented; thereby, application range is expanded so that face authentication can also be performed in a face image including relatively significant variation.

### BACKGROUND OF THE INVENTION

1. Field of the Invention

The present invention relates to image authentication apparatuses for authenticating a person by recollecting, from an image typically represented by a face image, an image that has been memorized using associative memory in advance, by complementing a significantly modified image part typically represented by partial face hiding using sun-glasses or a mask, etc., and by matching with a registered image.

2. Description of the Related Art

In a conventional image authentication apparatus, in a case in which a part of a face is hidden by a mask or sun-glasses, etc. when a face image is matched, in order to prevent difficulty of the personal identification due to a similarity score between a registered image and a matching image, the following system has been used. That is, a determination circuit for determining whether partial hiding is included in the face image when matched is provided; thereby, when determination is performed that the partial hiding is included, the authentication session is removed (for example, refer to Japanese Laid-Open Patent Publication 158,013/2004 (Paragraph [0046]-[0054], FIG. 4)). Moreover, when, by segmenting and matching the face image, a brightness value of the partial region abnormally and significantly differs, due to the mask or biased lightening, etc., comparing to a region corresponding to the registered image, the region is excluded (for example, refer to Japanese Laid-Open Patent Publication 323,622/2003 (Paragraph [0040]-[0041], FIG. 8)).

### SUMMARY OF THE INVENTION

In such image authentication apparatus, for example, because a face wearing a mask or sun-glasses goes out of the target to be authenticated, a problem has occurred that the applicable range of the face authentication system is narrowed. Therefore, application to a surveillance system to be an objective of detecting a suspicious person has been difficult. Moreover, according to the conventional system, because the method can only be applied to facial-part hiding having relatively high brightness contrast ratio due to a white mask, or black sun-glasses, etc., when the face is hidden by a hand, etc., the application is difficult; consequently, any characteristic deterioration has occurred. Additionally, when accompanying facial-expression variation, and also when accompanying variation due to a beard or additive variation due to glass sliding, a similarity score during the authentication is decreased; consequently, any characteristic deterioration has occurred.

An objective of the present invention, which is made to solve the above described problems, is to provide an image authentication apparatus that can deal a face image accompanying partial-hiding variation, facial-expression variation, or additive variation. Here, the system is supposed to be mainly applied to the face image; however, this technology is not limited to the face image, but can also be applied to a fingerprint image, etc., and moreover, can be widely applied to general images.

An image authentication apparatus according to the present invention includes an image input unit for photographing a frame image, a target extraction unit for extracting from the frame image an image to be matched in a target region, an image accumulation unit for accumulating registered images, an image recollection unit, once the registered images recorded in the image accumulation unit have been learned in advance by an associative memory circuit, for inputting into the associative memory circuit the image extracted by the target extraction unit, and outputting as a recollected image, an image matching unit for obtaining a similarity score by matching the registered image with the recollected image, and a result determination unit for determining an authentication result using the similarity score.

According to the image authentication apparatus of the present invention, the apparatus includes the image input unit for photographing a frame image, the target extraction unit for extracting from the frame image an image to be matched in a target region, the image accumulation unit for accumulating registered images, the image recollection unit, once the registered images recorded in the image accumulation unit have been learned in advance by the associative memory circuit, for inputting into the associative memory circuit the image extracted by the target extraction unit, and outputting as a recollected image, the image matching unit for obtaining a similarity score by matching the registered image with the recollected image, and the result determination unit for determining an authentication result using the similarity score; therefore, even when a part of the image inputted has more significant variation comparing to that of the registered image, the personal identification can be more suitably performed.

### BRIEF DESCRIPTION OF THE DRAWINGS

FIG. 1 is a block diagram illustrating a configuration of an image authentication apparatus according to Embodiment 1 of the present invention;

FIG. 2 is a view illustrating a processing operation for detecting a face from an inputted image according to Embodiment 1 of the present invention;

FIG. 3 is a view illustrating a self recollection circuit in an image recollection unit according to Embodiment 1 of the present invention;

FIG. 4 is a view illustrating an example of image recollection in the self recollection circuit according to Embodiment 1 of the present invention;

FIG. 5 is a view for explaining application of a face discrimination filter to a face image according to Embodiment 1 of the present invention;

FIG. 6 is an explanation view for calculating a face-authentication similarity score when matching is performed whether an image represents a person or another person according to Embodiment 1 of the present invention;

FIG. 7 is a view illustrating improvement of an authentication score by facial-image recollection according to Embodiment 1 of the present invention;

FIG. 8 is a view in which robustness is estimated against position deviation according to Embodiment 1 of the present invention;

FIG. 9 is a block diagram illustrating a configuration of an image authentication apparatus according to Embodiment 2 of the present invention; and

FIG. 10 is a view in which similarity score variation before and after recollection of an input image is represent in response to the registered images according to Embodiment 2 of the present invention.

### DETAILED DESCRIPTION OF THE PREFERRED EMBODIMENTS

### Embodiment 1.

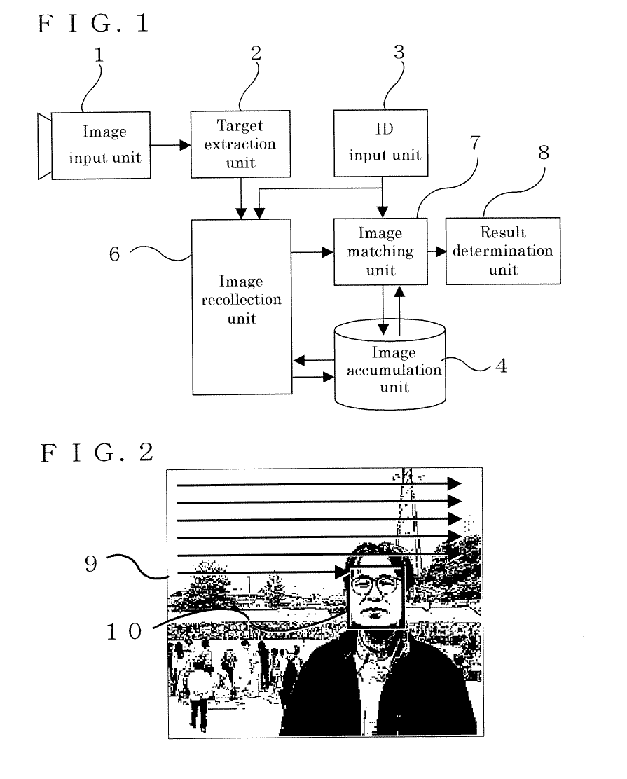

FIG. 1 is a block diagram illustrating a configuration of an image authentication apparatus according to Embodiment 1 of the present invention. An operation for newly registering a face image that does not include a hidden part and facial-expression variation and for constructing associative memory is explained using this block diagram. Moreover, an operation for matching a registered image with an image in which an inputted face image accompanying partial hiding by sun-glasses or a mask, etc. is recollected by the associative memory is explained.

First, an operation for newly registering the face image that does not include the hidden part and for constructing the associative memory is explained. An image in a target region to be matched is extracted by a target extraction unit 2 from a photograph image photographed by an image input unit 1 including a photograph system such as a camera. Specifically, a partial region such as a user's face to be a personal authentication target is extracted.

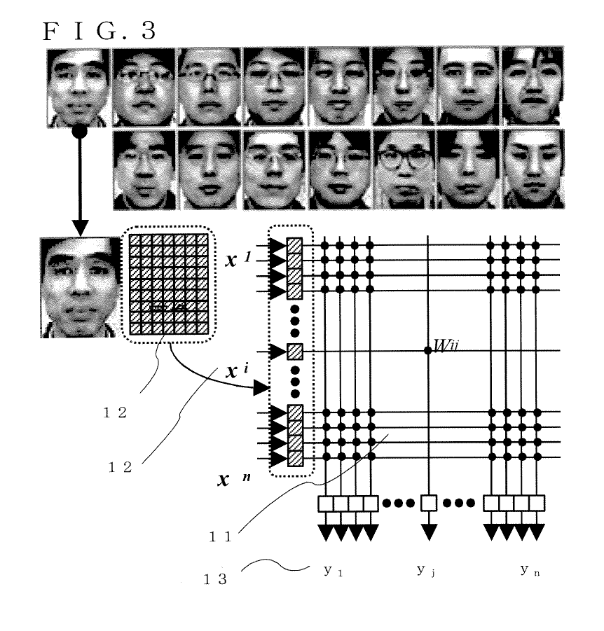

FIG. 2 is a view illustrating a processing operation for detecting a face from the inputted image in the target extraction unit 2. Hereinafter, a method of extracting an image in a scanned region 10 for detecting the face from a photograph image 9 including a human face is explained. Regarding the scanned region 10, scanning is performed from a comer to the other corner over the photograph image 9, for example, the scanning is performed from the left-upper comer to the right-lower corner of the image; thus, determination is performed whether the image at each position inside the scanned region 10 includes the face. When the face size included in the photograph image 9 is not constant, the scanning may be performed by varying the size of the scanned region 10. With respect to the above determination whether the face is included inside the scanned region 10, a conventional technology for detecting a face from an image, for example, a face detection method disclosed in U.S. patent application Ser. No. 5,642,431 may be used.

On the other hand, when an ID representing a new register is inputted into an ID input unit 3 for specifying a person, face-region images clipped by the target extraction unit 2 are registered as registered images 14 into an image accumulation unit 4 through an image recollection unit 6. Here, as the method of registering the registered images 14 into the image accumulation unit 4, it is not limited to this method. The ID for specifying the person is added to the personal-face image to be the image-authentication target, and is registered.

Here, a self recollection learning method of constructing auto-associative memory on an associative memory circuit 11 built-in the image recollection unit 6 is explained using registered images 14, stored in the image accumulation unit 4, of a plurality of persons. The self recollection learning method is one of the neural network methods for learning so that its output pattern agrees to its input pattern; moreover, the auto-associative memory, which is a kind of content-addressable memory, is a network to which the self recollection learning method is applied so that its output pattern agrees to its input pattern, and is a memory circuit having characteristics in which the entire desired output pattern is outputted even if a part of the input pattern is lacked.

FIG. 3 is a view for explaining the self recollection learning in the image recollection unit, which includes an input/output interface between the input image 12 and the output image 13, and the associative memory circuit 11. Each face image is inputted as the one-dimensional vector x=(x₁, . . . , xₙ) that is configured by one-dimensionally arranging each pixel of the input image 12, for example, by arranging the pixels from that at the left-upper comer to that at the right-lower corner, and combined with the one-dimensional vector y=(y₁, . . . , yₙ) of the output image 13 configured similarly to the input image 12 through a self recollection matrix W as the memory content of the associative memory circuit 11. Here, giving that the combination constant between the input xᵢ and the output yⱼ is Wᵢⱼ, y=Wx is obtained.

By treating a two-dimensional face image that a network learns is treated as the one-dimensional vector x, and minimizing the norm of the error vector (x−y) from the network output vector y given by the product of x and the self recollection matrix W, the learning is completed; thereby, the auto-associative memory using the face image can be created. That is, the self recollection learning is performed by updating each element of the self recollection matrix W towards the direction in which the absolute value of the output error (x−y) is minimized.

Specifically, K face images configuring a learning set are represented by a column vector x^{k}=(k=1, . . . , K), and, using the matrix X created by arranging x^{k} in each column, the self recollection matrix W is expressed by following Eq. 1.

$$W = {XX}^{T} = {\sum }_{k = 1}^{K} {{x}^{k} ( {x}^{k} )}^{T} \qquad [ Eq . 1 ]$$

Although the product y^{k}=Wx^{k} of the self recollection matrix W and the face image gives a self recollection result, because an error is generated between the output y^{k} and the input x^{k}, the error is minimized by updating the self recollection matrix W using the Widrow-Hoff learning rule.

Specifically, given that the number of steps is N, by following Eq. 2
W_{[N+1]}=W_{[N]}+η(X−W_{[N]}X^{T})X^{T} [Eq. 2]
the learning is intended to proceed; and by suitably choosing η (constant) desirable self recollection matrix W can be obtained.

Here, assuming that the Moore-Penrose pseudo inverse matrix of the matrix X is X+, the above matrix W_{[N]} converges to the following Eq. 3
W_{∞}=XX⁺ [Eq. 3]
therefore, W_{∞}can also be directly used as the desired self recollection matrix.

That is, images of the registered images 14 are decomposed for each image to individual pixel values x₁, . . . , xₙ as the input image 12, and the output image 13 is obtained from the pixel values y₁, . . . , yₙ obtained through the self recollection matrix W. The equation converged so that the difference between the input vector x and the output vector y becomes the minimum is the self recollection matrix W. Here, when the self recollection matrix W is obtained, a different one for each input image 12 is not obtained, but a single self-recollection-matrix W that is common to all images of a person to be the authentication target registered as the registered images 14; thereafter, the above self recollection learning is completed.

Accordingly, the obtained result by learning so that the output pattern becomes as equal as possible to the input pattern is the self recollection matrix W, which constitutes the associative memory circuit 11. Using this result, even though a part of the input pattern is lacking, the entire of the desired output pattern can be outputted. In the image recollection unit 6, the input image 12 extracted by the target extraction unit 2 is treated as input, and then the recollected image 13 is outputted through the associative memory circuit 11 learned by using the registered images 14 that have been previously recorded in the image accumulation unit 4.

In this embodiment, the input image 12 that is used when the self recollection matrix W is obtained from the self recollection learning is assumed to be an image in which neither partially hidden faces nor various facial expressions are included, and this method is equivalent to a concept as the registered image to be a premise for generally authenticating faces. Taking this concept as the premise, and using the face images including the partially hidden faces or the various facial expressions, the original face image that includes neither the partially hidden faces nor the various facial expressions is recollected. Thereby, in the image recollection unit 6, the self recollection matrix W as an actual substance of the memory content included in the associative memory circuit 11 has been constructed by learning using the registered image 14. This associative memory circuit 11 constructs the recollected image 13 in which hidden parts, etc. are compensated in response to images having partially hidden parts, etc. explained as follows. Here, both of the output image and the recollected image are images obtained by the self recollection matrix W, and mean to be respectively equivalent to each other; however, in this embodiment, when obtaining of the self recollection matrix W is mainly concerned, the term “output image” is used; meanwhile, when the image is outputted using the self recollection matrix W, the term “recollected image” is used.

Here, the self recollected image 13 is not based on the result of the calculation using two images that are the personal registered image 14 specified by the ID input unit 3 and the input image 12 having the partially hidden part. The self recollected image 13 can be obtained as output of the image recollection unit 6, once the self recollection matrix W is fixed in advance using all of the registered images 14. As described later, in the image matching unit 7, the personal registered image 14 specified by the ID input unit 3 is persistently used together with the recollected image 13, and is used for calculating a similarity score for matching the person.

Next, an operation for matching with the registered image the input face image accompanying a varying part of the face image represented by the partial hiding, etc. Similarly when the image is registered, the face-region image is clipped by the target extraction unit 2 from the photograph image included in the image input unit 1, and simultaneously, the identification whether the user face has been registered is performed by the user ID inputted through the ID input unit 3. If the user face has not been registered, the personal authentication using the face image is stopped. On the other hand, if the user face has been registered, the image recollection unit 6 outputs to the image matching unit 7 the input image 12, to be the face image having been clipped, as the recollected image 13 in which the varying portion is complemented by the associative memory circuit 11. At the same time, the registered image 14 that is a face image registered in the image accumulation unit 4 based on ID inputted in the ID input unit 3 is loaded on the image matching unit 7, the output image 13 as the recollected image and the registered image 14 are matched; then, the similarity score 15 is obtained, and outputted to the result determination unit 8.

Here, a face-image part detection step and a normalization step in the process from the image input unit 1 to the image matching unit 7 are specifically explained. After the face image as the target region to be matched is extracted and segmented, in the target extraction unit 2, from the frame image photographed in the image input unit 1, as a part detection step, the characteristic points such as the tail of the eyes and the lips whose positions are relatively stable are detected from the face detection region. Next, in a normalization step, the position deviation, tilt-angle, and size, etc. of the face are compensated with the detected characteristic points being used as the reference, normalization processing needed for the face authentication is performed, and the result is inputted into the image recollection unit 6. Moreover, by matching in the image matching unit 7 the registered image 14 that is registered in the database in the previously normalized form, with the recollected image 13 recollected in the image recollection unit 6, the score of the similarity score 15 is calculated, discrimination whether the image is specified as the person or another person is performed by determining in the result determination unit 8 using a threshold value; thus, the authentication processing is completed. Thereby, the result determination unit 8 performs, based on the similarity score 15, the personal authentication determination.

Determination using the threshold value is performed, based on the similarity score 15, in the result determination unit 8; for example, a determination result is represented in which, when the similarity score is not smaller than the threshold value the image is specified as the person, while when the score is smaller than that value the image is specified as another person. In the result determination unit 8, a display device such as a monitor is included; therefore, the user can check his photographed face, and can also get the determination result of the system.

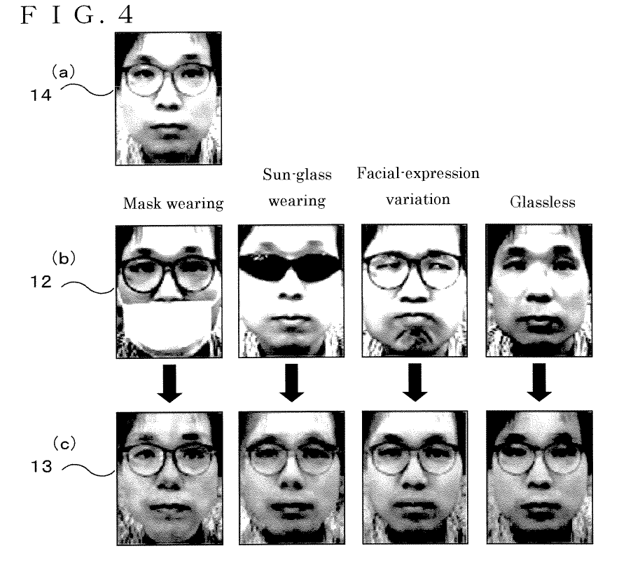

FIG. 4 is a view illustrating an example of image recollection according to the self recollection memory. An example is represented how the face-image partial hiding that can be considered to occur in a practical operation is recollected. When an image in FIG. 4(a) is used as the registered image 14 that is the original image, and each image in FIG. 4(b) is used as the input image 12 including partial hiding, etc., each recollected image recollected by the image recollection unit 6 corresponds to each output image 13 in FIG. 4(c). The partial hiding is complemented, and then the matching with the registered image 14 becomes possible. In FIG. 4(b), examples of a mask-wearing image, a sun-glass-wearing image, a facial-expression varying image, and a glassless image are presented in sequence from left to right. It can be found that not only the complement of the hidden part is possible, but also the facial-image recollection using the auto-associative memory effectively operates for restoring the original image.

In order to estimate how robust the facial-image recollection result represented in FIG. 4(c) can recollect an original image (a), it is not enough to check only the difference at the pixel level. Quantitative estimation from the view point of the personal match using the face image is needed. That is, it is needed to be assessed how the similarity score as the facial authentication score is increased, comparing with a case in which the recollection result (c) against the original image (a) includes the partial hiding (b).

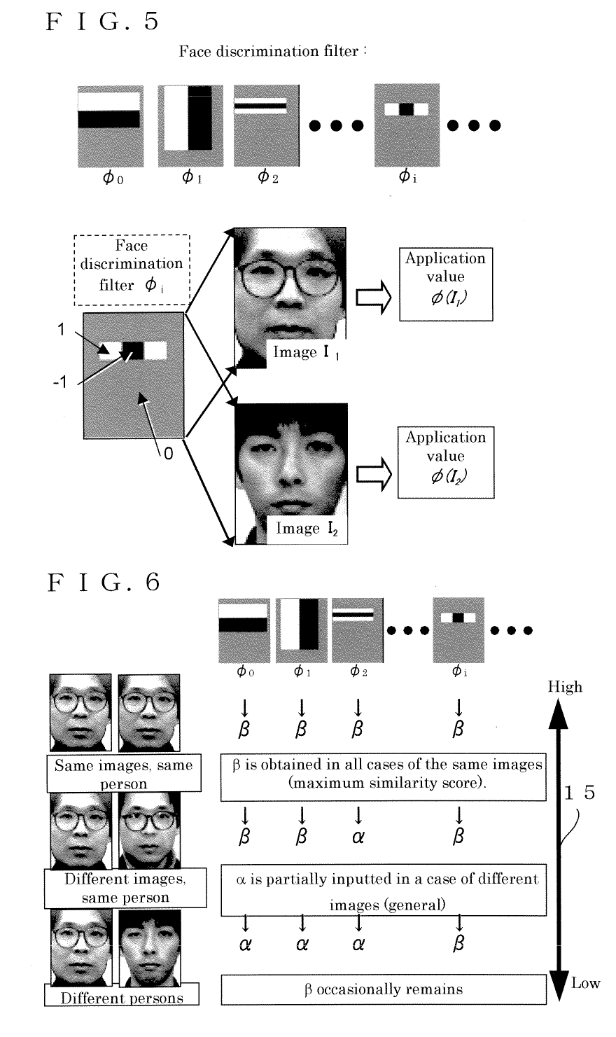

Therefore, as an example how the registered image (recorded image) 14 and the output image (recollected image) 13 as the matching image are matched, and the score of the similarity score 15 is calculated, explanation is performed using FIG. 5 and FIG. 6. FIG. 5 is a view for explaining that a face discrimination filter is used for the face image; meanwhile, FIG. 6 is an explanation view for calculating the face-authentication similarity score when matching is performed whether the image represents a person or another person.

First, when two face images that are the registered image (recorded image) 14 and the output image (recollected image) 13 as the matching image are matched to each other, positions of the eyes and mouth, etc. are compensated by the normalization step as described above. Accordingly, the local image characteristics such as brightness gradient are reflected as the difference between the face images. By assuming this reflection, and preparing the face discrimination filters φ₀, φ₁, . . . φᵢ, . . . as represented in FIG. 5, the filters are applied to these two face images. Here, each face discrimination filter has the same size as the normalized face image, and a coefficient is applied to each pixel of the normalized face image.

Specifically, the white region has the coefficient of 1, the black region has the coefficient of −1, and the other region has the coefficient of 0 (the grey region in the figure), and by multiplying (practically adding and subtracting) with each pixel, a filter application value is calculated. In the figure, application values of filters φ in response to images I_{1,} and I₂ are assumed to be φ(I₁), and φ (I₂), respectively, and, if the absolute value of the difference between the image I₁ and I₂ values calculated for each filter φ is smaller than T, assuming that the similarity score between the two images is high, the output result related to the filter φ is assumed to be β(>0), meanwhile if the absolute value is not smaller, the output result is assumed to be α(<0). By applying the result to all face discrimination filters φ₀, φ₁, . . . φᵢ, . . . , or calculating the sum of a α or β, the similarity score 15 of the two face images are calculated.

FIG. 6 is a view illustrating an example of the above similarity score calculation. The calculation of the similarity score 15 between the left-side registered image 14 and the right-side matching image as the recollected image 13 is explained, in which each filter output is included. In a case of the same images of the same person, the output value in response to each filter goes to β and the similarity score 15 goes to the maximum. On the other hand, in response to the face images photographed under different states of the same person, because α is accompanied in some filters, the similarity score 15 decreases comparing to the case in which the images completely agrees to each other. However, the similarity score 15 generally goes to a positive and a high-score value. At last, when another person's face is matched, although some β remains, α mostly agrees to the output value; therefore, the similarity score 15 decreases.

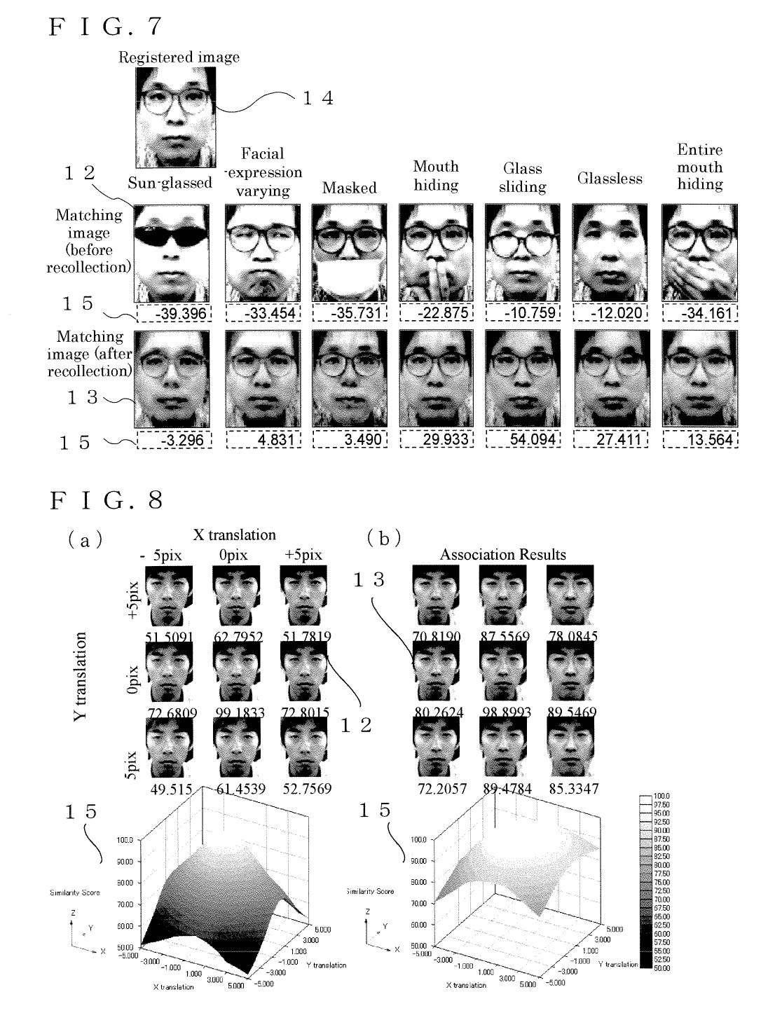

FIG. 7 is a view illustrating improvement of the authentication score by the facial-image recollection. Specifically, in response to the registered image 14, the similarity scores 15 of the input images 12 as images before recollection are represented in the upper portion, meanwhile the similarity scores 15 of the output images 13 as images after recollection are represented in the lower portion. In response to the left-end registered image 14 that includes neither partial hiding nor facial-expression variation, seven kinds of sample images are prepared, in which the partial hiding of the face by sun-glasses, a mask, or a hand, and the variation based on facial-expression and glass wearing, etc. are included. By considering as the match face images the face images before and after application of the face recollection in response to the registered image 14, and applying the previously described face authentication algorithm, the similarity score 15 is calculated. In every case, the similarity score 15 after the recollection is improved in response to that before the recollection. In a case in which the threshold value related to the similarity score 15 for determining the person is assumed to be nil, determination to be the person is not necessarily performed before the recollection. However, after the recollection, except for the sun-glass wearing case, a result determined to be the person is obtained. This result represents that the face recollection using the auto-associative memory is effective not only in the partial hiding as the problem of the conventional face authentication algorithm, but also in the facial-expression variation and the wearing variation, etc.; specifically, this system contributes to improvement related to false rejection error.

FIG. 8 is a view in which robustness against the position deviation is estimated. Specifically, in this figure, variation of the authentication score is estimated against the position deviation when the face image is recollected using the auto-associative memory. In FIG. 8(a), the input images 12 each, obtained when the registered image 14 as the original face image represented in the center is moved up, down, left, or right for ±5 pixels, is represented, and distribution of each similarity score 15 of the face image obtained after the pixel movement against the central face image (the vertical axis represents the similarity score). In FIG. 8(b), distribution of each similarity score 15 between each recollected image 13 obtained when each face image is recollected using each input image 12 corresponding to each pixel movement, and each input image 12 after the pixel movement, as represented in FIG. 8(a), is represented. Judging from this result, the recollection ability generally decreases due to the position deviation; however, if the position deviation is approximately within ±5 pixels, the similarity score becomes not lower than 70; consequently, it is found that the sufficient recollection ability can be maintained.

According to such configuration, complement action against the face image is brought by the image recollection unit 6 having the associative memory circuit; thereby, the varying portion of the face such as the partial hiding in the matching image is complemented, and a face image close to the registered image is reconstructed. Therefore, not only when accompanying the partial hiding of the face using the mask or the sun-glass, etc., but also when accompanying the facial-expression variation, the face authentication can be applicable.

By providing the image recollection unit 6 having the associative memory circuit 11 as described above, even when the hidden part such as the masked or sun-glassed portion is included in the face image, the personal authentication using the face image becomes possible, and also even when the facial-expression variation other than the partial hiding is accompanied, the personal authentication becomes possible by passing through the facial-image recollection. Moreover, in another case that is not the partial hiding, for example, also in the case of varying the usual wearing glasses, wearing and removing the glasses, varying the hair style across the ages, or growing or not growing the beard, which the conventional and normal face-authentication system has excluded from its specification, application to the face authentication system becomes possible.

Now, various problems to improve the performance of the face authentication algorithm are pointed out; specifically, five causes related to partial hiding, facial-expression variation, variation across the ages, lighting varying, and face-direction variation can be pointed out. The present invention is especially effective to the partial hiding, the facial-expression variation, and the variation across the ages among them. Here, if the lighting varying is a localized one, it can be considered similar to the partial hiding. Moreover, regarding the face-direction variation, if the variation as the face image is a partial one, it can be considered similar to the partial hiding; therefore, the present invention is effective similar to the partial hiding, the facial-expression variation, and the variation across the ages.

The image authentication apparatus includes the image input unit 1 for photographing the frame image, the target extraction unit 2 for extracting from the frame image the image to be matched in the target region, the ID input unit 3 for specifying the person, the image accumulation unit 4 for accumulating the registered images 14, the image recollection unit 6, once the registered images 14 recorded in the image accumulation unit 4 has been learned in advance by the associative memory circuit 11, for inputting into the associative memory circuit 11 the image extracted by the target extraction unit 2, and outputting as the recollected image 13, the image matching unit 7 for obtaining the similarity score 15 by matching the personal registered image 14, which is specified by the ID input unit 3, with the recollected image 13, and the result determination unit 8 for determining the authentication result using the similarity score 15; therefore, when the partial image inputted is hidden, when the facial-expression variation is included, and even when the additive variation is included, the person authentication can be suitably performed.

### Embodiment 2.

In Embodiment 1, an example has been explained in which, by specifying a user through the ID input unit 3, the apparatus is used as a one-to-one face authentication system for authenticating with a single registered candidate a single person to be matched. However, not by specifying the user, the present invention can also be used for one-to-N matching for matching with all of the registered persons a person corresponding to an arbitrary face image included in the input images.

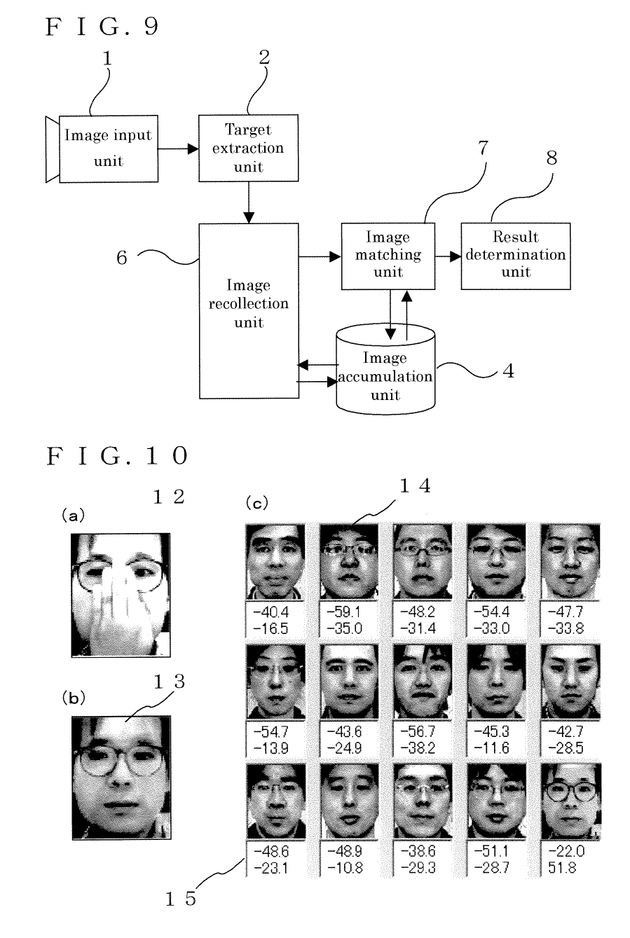

FIG. 9 is a block diagram illustrating a configuration of an image authentication apparatus for performing the authentication without specifying in advance a target person to be authenticated. In response to Embodiment 1, it is configured that the ID input unit 3 is omitted. Except for the portion related to the one-to-N matching, the configuration is similar to that described in Embodiment 1.

That is, using the user's registered image 14 registered in advance, the recollection matix W is obtained in advance by the associative memory circuit 11 provided in the image recollection unit 6. Due to this associative memory circuit 11, in response to the user's face image registered in advance, not only when the partial hiding is not included, but also when the partial hiding is included, regarding the recollected image 13 recollected by the image recollection unit 6, the similarity score 15 of the person's registered image 14 among all of the registered images that are one-to-N matched in the image matching unit 7 increases. On the other hand, even if the matching with the registered image 14 other than the person's is performed, the similarity score does not increase. Generally, if the input image 12 is a face image being different from any one of the previously registered user's image, even if the input image 12 accompanies the partial hiding, regarding the recollected image 13 recollected by the associative memory circuit 11, the similarity score 15 of any one of the registered images 14 registered in the image accumulation unit 4 does not increase.

In Embodiment 1, the ID input unit 3 is provided for specifying a person; thereby, an example has been explained in which a single-personal registered image 14 specified in the ID input unit 3 is used. On the other hand, in this embodiment, because all of the registrants are targets to be authenticated, matching with all of the registered images 14 registered in the image accumulation unit 4 is performed.

In response to 15 persons' face images used for the auto-associative memory learning, with respect to a person included in the registered images, a face accompanying the partial hiding is used as the matching image; thereby, it has been checked, using the face authentication algorithm in response to the 15 registered images, how the similarity scores 15 of the original face image before the recollection due to the auto-associative memory and the face image after the recollection are changed before and after the recollection.

FIG. 10 is a view representing similarity scores before and after the face recollection being estimated with respect to the authentication score estimation with all of the registered images. FIG. 10(a) is a matching image before the recollection; FIG. 10(b) is a matching image after the recollection; and FIG. 10(c) is registered face images for 15 persons, which are all of the face images used for the self recollection learning. Numerals given under each face image in FIG. 10(c) represent the similarity scores 15, where upper and lower ones represent the similarity scores 15 with the matching images before and after recollection, respectively.

As is obvious from this result, when the threshold value for determining the person is set to “0”, every score including that of the personal registered images, before the recollection, becomes not higher than the threshold value, and thus, the false rejection occurs. On the other hand, after the recollection, only the score against the personal registered image drastically increases comparing to the other scores. That is, it is found that the problem of the false rejection is resolved, and the personal matching is correctly performed.

A registered image whose similarity score 15 calculated using two face images in the image matching unit 7 is not lower than a predetermined threshold value is obtained by the result determination unit 8, without distinguishing between registered and unregistered face images as the target to be matched. When the score does not exceed the threshold value even if all of the registered images are used, the authentication is rejected. On the contrary, when a plurality of the registered images 14 whose similarity scores each exceeds the threshold value is found, the plurality of the candidates is, for example, displayed on the display device provided in the result determination unit 8.

Moreover, when the one-to-N matching is performed, the matching operation is not necessary to perform against all the registered images 14. At the stage when the registered image 14 whose similarity score 15 exceeds the threshold value is found, the authentication is performed that the image corresponds to the person; then, the matching operation after the authentication can also be discontinued. Moreover, if information from the ID input unit 3 is not included, by prioritizing an image order for the registered images 14 in the image recollection unit 6 and the image matching unit 7, based on another information such as a criminal record, the authentication can be completed more speedily.

Furthermore, the present invention can be used not only for controlling the entrance/exit of a room, but also for searching in the blacklist for detecting a suspicious person.

Therefore, because the image authentication apparatus includes the image input unit 1 for photographing a frame image, the target extraction unit 2 for extracting from the frame image an image to be matched in a target region, the image accumulation unit 4 for accumulating registered images, the image recollection unit 6, once the registered images 14 recorded in the image accumulation unit 4 have been memorized in advance by the associative memory circuit 11, for outputting as the recollected image 13 the input image 12 extracted by the target extraction unit 2, the image matching unit 7 for obtaining the similarity score 15 by matching the registered image 14 with the recollected image 13, and the result determination unit 8 for determining an authentication result using the similarity score 15, when a part of the inputted image is hidden, even if, comparing to the registered image, relatively significant variation of the face image such as facial-expression variation is accompanied, the personal matching can be more suitably performed.

### Embodiment 3.

In addition to the configurations in Embodiments 1 and 2, an occlusion-check circuit for determining whether a hidden part is included in the target region of the target extraction unit 2 is provided in Embodiment 3. When a result in which the hidden part is not included is obtained by the occlusion-check circuit, the image matching unit 7 does not match with the recollected image 13, but directly matches the registered image 14 with the input image 12; thereby, the similarity score 15 is obtained.

If the occlusion-check circuit is added into Embodiment 2, for example, in a video surveillance system, when a plurality of persons always passes in front of the surveillance camera, by defining the person who wears sun-glasses or a mask as a suspicious person, the surveillance focused on a suspicious person can be performed. As described above, by monitoring limited to the suspicious person using the occlusion-check circuit of the target extraction unit 2, the processing load during the operation of the system can be reduced comparing to the case in which processing of the image recollection unit 6 in response to all the face detection regions is utilized.

Moreover, when judgment by the occlusion-check circuit of the target extraction unit 2 is performed in which the hidden part is not included in the face image, the processing of the image recollection unit 6 is skipped, and the face image is directly stored into the image matching unit 7, and then matching processing may be performed, or judgment is performed in which suspicious persons are not included and any processing is not performed, and then the processing of the target extraction unit 2 may be repeated.

In order to realize an occlusion-check circuit, if a computer previously learns a sun-glassed face and a masked face, in addition to the face detection function already provided in the target extraction unit 2, hereinafter, the sun-glassed face and the masked face included in the frame images of the surveillance camera can be detected. Therefore, this algorithm may be configured as the occlusion-check circuit of the target extraction unit 2. Alternatively, by simply analyzing the characteristics, as a brightness-distribution equivalent image, inside the detected face region, the occlusion-check of the face image may be performed.

Here, the occlusion-check circuit is not limited to the determination whether the hidden part is included in the target region. The occlusion-check circuit determines whether a special variable portion is included in the target region of the target extraction unit 2, and includes a case of significant facial-expression variation, etc.

### Embodiment 4

Although in Embodiments 1-3, as an example in which the face is used as the detection target included in each image, the explanation has been performed using the face image as the target to be matched, the image authentication apparatus may be configured in which another biometrics information such as fingerprint is used as the target. Even though partial lack of the input image is included, the hidden part is complemented by the associative memory circuit 11 provided in the image recollection unit 6, and the applicable range of the personal matching using the biometrics image can be extended.

Moreover, also in a case of the fingerprint, etc., when, by installing the occlusion-check circuit in the target extraction unit 2, determination is performed that the hiding is not included, by skipping the processing in the image recollection unit 6, the processing load can be reduced.

Furthermore, in the above embodiments 1-4, as the image treated in the image input unit 1, it is not limited to the frame image directly inputted from the camera input. By inputting a still image recorded in the image data base, etc., processing may be performed similarly to the case of the frame image from the camera.

What is claimed is:

1. An image authentication apparatus comprising:
an image input unit for photographing a frame image;
a target extraction unit for extracting from the frame image an image to be matched in a target region;
an image accumulation unit for accumulating registered images;
an image recollection unit, once the registered images recorded in the image accumulation unit have been learned in advance by an associative memory circuit, for inputting into the associative memory circuit the image extracted by the target extraction unit, and outputting as a recollected image;
an image matching unit for obtaining a similarity score by matching the registered image with the recollected image; and
a result determination unit for determining an authentication result using the similarity score.

2. An image authentication apparatus as recited in claim 1 further comprising an ID input unit for specifying a person, wherein a personal image specified in the ID input unit is used as the registered image used in the image matching unit.

3. An image authentication apparatus as recited in claim 1, wherein the target extraction unit includes an occlusion-check circuit for determining whether a hidden part is included in the target region.

4. An image authentication apparatus as recited in claim 3, wherein the similarity score is obtained by matching the registered image with the extracted image in the image matching unit when the ocdusion-check circuit determines that the hidden part is not included.

5. An image authentication apparatus as recited in claim 1, wherein the target to be matched is a face image.
